(19) United States
(12) Patent Application Publication
(10) Pub. No.: US 2017/0270458 A1
(43) Pub. Date: Sep. 21, 2017

(54) Assignment of group

(71) Applicant: Geert Arthur Edith Van Wonterghem, Zwijndrecht (BE)

(72) Inventor: Geert Arthur Edith Van Wonterghem, Zwijndrecht (BE)

(21) Appl. No.: 15/516,057

(22) PCT Filed: Oct. 1, 2015
(86) PCT No.: PCT/BE2015/000047

§ 371 Date: Mar. 31, 2017

(30) Foreign Application Priority Data
Oct. 3, 2014 (BE) 2014/0735

(51) Int. Cl. G06Q 10/06; G06Q 10/10; G06Q 50/00

(52) U.S. Cl. CPC G06Q 10/063112; G06Q 50/01; G06Q 10/103

(57) ABSTRACT

Method for forming subgroups within a group, wherein a database is available which quantifies a relation between persons from the group, wherein the method comprises the steps of: —forming a subgroup by selecting a set of persons from the group according to a predetermined algorithm in a manner such that the relation between persons in the set is quantified above a predetermined threshold value; —designating each person from the set of persons as persons assigned to subgroups; wherein the repetitive performance stops in one of the following situations: —all persons from the group have been assigned, after which the method further comprises of communicating the subgroups via a user interface; and —in the collection the relations are quantified below the predetermined threshold value, after which the method further comprises the following step of: —restarting the repetitive performing of the steps with a different predetermined algorithm.

The invention relates to a method for forming subgroups within a group of persons.

Organized for both business and personal purposes are all manner of events at which people can meet each other. The events can have a specific context here. Professional networking events can thus be organized with the purpose of bringing together complementary business profiles. Dating events can also be organized at which people can meet each other and begin a personal relationship. A relatively large group of people is typically present at such events, and the persons are subdivided during the event into subgroups, for instance per pair, so that the persons in the subgroup can become acquainted with each other. In practice this subdivision typically takes place at random. People standing in the vicinity of each other begin a conversation at their own initiative and with the hope of a positive outcome. Because meetings between people at events are at random, the efficiency of such an event is not optimal, at least not for all the people participating.

It is an object of the invention to provide a method with which the efficiency of an event can be optimized.

The invention provides for this purpose a method for forming subgroups within a group, wherein the group comprises a predetermined number of persons and wherein a database is available which quantifies a relation between each possible pair of the group, wherein the method comprises of repetitively performing the steps, by means of a processor, of:
forming a subgroup from a collection of persons from the group not yet assigned to subgroups by selecting a set of persons from the group according to a predetermined algorithm in a manner such that the relation between the persons in the set is quantified above a predetermined threshold value;
designating each person from the set of persons as persons assigned to subgroups;

wherein the repetitive performance stops in one of the following situations:
the collection of persons from the group not yet assigned to subgroups comprises fewer than a predetermined remaining number of persons, after which the method further comprises of communicating the subgroups via a user interface; and
in the collection of persons from the group not yet assigned to subgroups the relations are quantified below the predetermined threshold value, after which the method further comprises the following step of:
   restarting the repetitive performing of the steps with a further predetermined algorithm differing from predetermined algorithms previously applied in the method.

The invention is based on the insight that the participants at events are typically known in advance. As a result a database can be built up beforehand in which the relation between each of the participants in the event is quantified. The skilled person will appreciate here that quantifying of the relation can be very elementary and based on freely accessible information or on information obtained when the person registers for the event. The quantifying of the relation can alternatively be performed via complex algorithms in which detailed information, for instance from social network sites, personal websites or company websites, is filtered and used to quantify the relation. Quantifying relations between persons in the group enables meetings between persons at an event to be controlled such that the chance of a positive outcome to the meeting increases considerably. The method provides a mechanism here which ensures that all persons from the group come together in a subgroup with other persons wherein the mutual relation is quantified above a threshold value. In order to realize this the method comprises a mechanism for forming the groups, wherein the process of forming the groups is stopped when almost all persons have been assigned to a group (in the claim this is worded as: when the collection of persons from the group not yet assigned to subgroups comprises fewer than a predetermined remaining number of persons) or is stopped when it is impossible to form a new group with relations quantified above the predetermined threshold value. In the latter case the forming of the groups will be restarted with another algorithm so that other combinations of persons are made and other subgroups are thus formed, and almost all persons from the group can be assigned to subgroups with a relation which is quantified above the predetermined threshold value. An example hereof is described below. By applying the method according to the invention the outcome of an event will no longer depend on “hit-and-miss”, but the efficiency of the networking event, in particular a physical event, can be optimized by controlling the forming of subgroups.

The subgroup is preferably a pair. It is typically an objective at events to allow people to get to know each other. The greatest efficiency is achieved for both business and private purposes when subgroups consist of two persons, in other words a pair.

The method preferably further comprises the following steps, when the step of restarting repetitive performing of the steps with a further predetermined algorithm differing from predetermined algorithms previously applied in the method has been exhausted, of:
repeating the whole method with a further predetermined threshold value lower than previously applied predetermined threshold values.

This step allows a start to be made with a predetermined threshold value which is relatively high such that there is a strong chance of a successful outcome to the meeting between the persons. However, the higher the threshold value, the smaller the chance that the whole group can be assigned to subgroups wherein each subgroup has a relation quantified above the high threshold value. If no combination can be found by the predetermined algorithms, the threshold value can therefore be reduced such that the group can still be assigned in a balanced manner and wherein an efficiency is still achieved which is higher than in a situation in which meetings take place at random.

A plurality of predetermined algorithms is preferably stored in memory, which memory is operatively connected to the processor. Each algorithm has for instance a specific approach here to selecting a set of persons in the group such that, by using different approaches, the group is assigned in different ways. A first algorithm can thus employ an alphabetic approach, wherein the alphabetic order determines which persons are placed together, wherein other conditions such as the threshold value must of course also be satisfied. An algorithm can alternatively be provided which gives priority to the highest quantification of relations between persons in the forming of subgroups. It will be apparent to the skilled person that these two examples of algorithms will assign the same group to subgroups in different ways. Applying different algorithms allows the group to be assigned in different ways with the same predetermined threshold value as minimum for the quantified relation.

The database is preferably stored in a memory, which memory is operatively connected to the processor. The processor can in this way use the data in the database for the purpose of determining the subgroups.

The invention further relates to a method for controlling meetings between persons during an event, wherein the method comprises of:
setting a predetermined period of time per meeting;
performing the method according to the invention for each period of time;
communicating the end of the predetermined period of time for each period of time.

Meetings during the networking events are hereby limited in time. It will be apparent that this limitation in time is not binding for participants, but is encouraged and/or controlled by the method according to the invention. By having the meetings last a predetermined period of time the moment at which subgroups are reassigned is synchronized. As a result many or even all persons are available between two periods of time for reassignment to a subgroup. This allows the system to once again generate and communicate an optimal assignment of persons so that the efficiency of the event is further optimized.

The step of communicating the subgroups via a user interface preferably further comprises of storing, for each person from the subgroup, the other persons from the subgroup as relations, and wherein the set of persons is selected such that the set of persons is formed by persons who are not relations. Meetings which have already taken place during the event are hereby stored for each person. Taking this into account in the forming of subgroups avoids someone being placed more than once with the same person. The term “relations” used in the claim stems from the idea that, when two persons have met each other during the event, they have established at least a basis for a relation, and these persons can hereby be deemed as relations of each other. In practice this indication merely means that the two persons have already been assigned to a subgroup with each other during the event.

The availability of persons in the group is preferably dynamic and the collection of persons from the group not yet assigned to subgroups comprises only the persons available. The database preferably further comprises for each person an availability value which comprises the availability of each person, which availability value can be modified via a user interface connected to the processor and the memory. Each person can hereby indicate at any moment during the event whether he/she is available again for assignment to subgroups. When a person in a subgroup is having an interesting conversation, and does not yet wish to end the conversation after the predetermined period of time, the persons in this subgroup can indicate that they are not available for a following meeting. The availability value is typically a boolean and indicates whether a person is or is not available for a meeting.

The invention will now be further described on the basis of an exemplary embodiment shown in the drawing.

In the drawing:

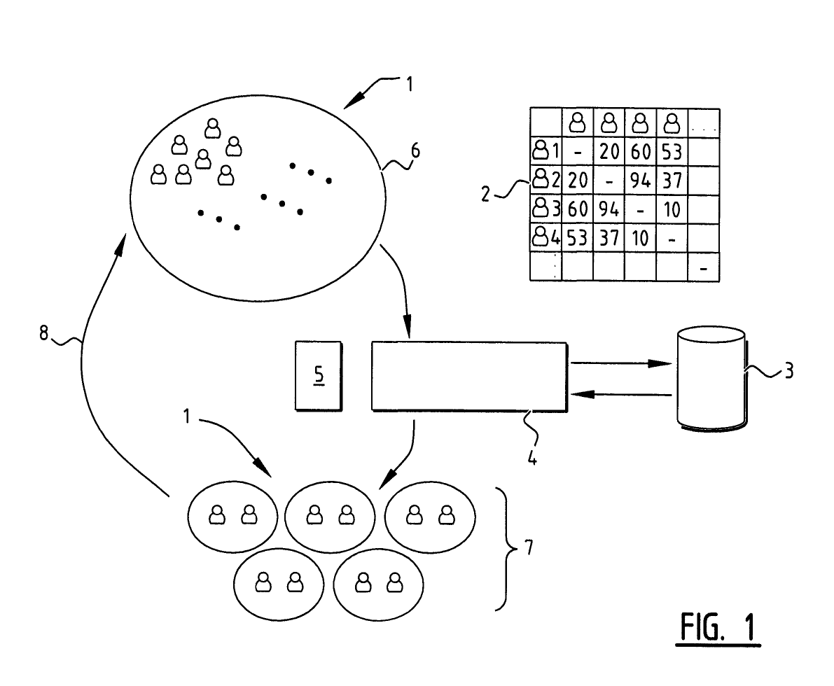

FIG. 1 shows a schematic diagram of a situation in which the method according to the invention can be applied; and

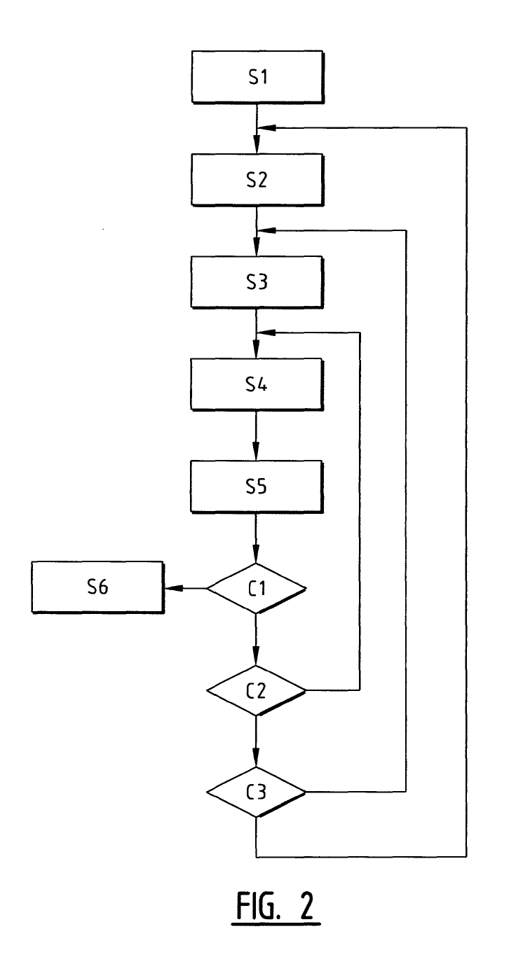

FIG. 2 shows steps of the method according to the invention.

The same or similar elements are designated in the drawing with the same reference numerals.

FIG. 1 shows a situation in which a group of persons 1 is present at an event. Group 1 is defined as all persons present at an event, including persons not yet assigned to subgroups (shown in the upper part of FIG. 1 and designated with reference numeral 6), as well as the persons already assigned to subgroups (as shown at the bottom of the figure and designated with reference numeral 7).

Different types of event can form a basis for performing the method according to the invention. A dating event can thus form the basis for performing the method according to the invention, wherein the object of performing the method is to increase the chance that a successful romantic relationship results from a meeting between persons at the event. Business networking events can also form a basis for performing the method according to the invention, wherein the object is to increase the chance of a successful business relationship resulting from a meeting between persons at the event. An event with a large group of persons, wherein a large group of persons is defined as a group of more than 20 persons, preferably more than 40 persons, more preferably more than 60 persons, begins with the identification of each of the persons participating in the event. This identification can take place beforehand, or can take place at the beginning of the event itself. Diverse personal data and/or preferences can be collected during the identification. It will be apparent that identification in the context of the invention does not necessarily mean that the identity of the person is known, but that predetermined information relating to the person (for instance personal characteristics, business-related and other characteristics, . . . ) is known. It will be apparent to the skilled person that such information can be obtained in different ways, for instance by having each of the persons fill in a form or by searching, on the basis of the names of the persons, for predetermined information in online databases (for instance via social media). This information can then be stored or used directly to create a database 2, which will be further elucidated below.

Database 2 is stored in a memory 3 which is operatively connected to a processor 4. Database 2 comprises for each person from the group 1 a quantification of the relation with each other person from the group 1. The quantification of the relation indicates here how great a chance there is of a positive outcome to a meeting between the relevant persons in the context of the event. This quantification is typically based on the predetermined information collected for each of the persons. It will be apparent to the skilled person here that, depending on the type of event, different known algorithms can be applied in order to quantify a relation on the basis of predetermined information. Depending on which information is known about the persons, this quantification can be simple to highly complex. The forms this quantification takes can also differ. A simple quantification can thus be formed by a boolean, wherein a simple distinction is made between high or low chance of a successful outcome to a meeting. A quantification can alternatively be formed by a value which quantifies the relation. In the example of FIG. 1 database 2 comprises for each combination of persons a value between 0 and 100, wherein 0 indicates that the chance of a positive outcome to a meeting is extremely low and 100 indicates that the chance of a positive outcome to a meeting is extremely high. Intermediate values indicate proportional chances of a positive outcome to a meeting.

By performing the method according to the invention the group of persons 1 is assigned to subgroups in a manner such that for each subgroup the chance of a positive outcome lies above a predetermined threshold value. This takes place in a number of steps which will be elucidated below on the basis of FIG. 2 and with reference to FIG. 1.

FIG. 2 shows a first step S1, being generation of the database in which relations between persons from the group of persons 1 are quantified. This database is illustrated in FIG. 1 with reference numeral 2. The database is typically stored in a memory 3 which is operatively connected to processor 4. Processor 4 is preferably provided here for the purpose of performing at least some of the steps of the method. It will be apparent to the skilled person that the database can also be generated elsewhere and transferred to memory 3.

Step S2 is the step of determining a threshold value. The threshold value can be determined on the basis of an algorithm. The threshold value can alternatively be set by an operator to a predetermined value which is provided so as to remain unchanged during the method. As further alternative and in preference, the threshold value can be determined dynamically by processor 4, wherein the threshold value is initially as high as possible and wherein the threshold value is only reduced when the method according to the invention is no longer able to subdivide the group into subgroups with this high threshold value (as will be further elucidated below).

Step S3 is the step of selecting an algorithm for forming the subgroups. Database 3 preferably comprises a plurality of algorithms which have a different approach to assigning the group to subgroups. The term “a plurality of algorithms” will be broadly interpreted here, and an algorithm which can be provided with parameters in different ways so as to produce different results will also be deemed “a plurality of algorithms”.

In step S4 a subgroup is selected from a collection of persons available from the group of persons by the processor on the basis of database 2 by applying the algorithm selected in step S3. It will be apparent here that in practice the collection of available persons is at the most equal to the group of persons 1, but is typically only a part of the group 1. In FIG. 1 this collection is designated with reference numeral 6. The collection typically comprises persons available for assignment to subgroups. It will be apparent here that persons who have already been assigned to subgroups, as designated with reference numeral 7 in FIG. 1, no longer form part of the collection. There may further be all manner of reasons influencing the availability of a person. A person may for instance have gone to the toilet, a person may leave the event early, and so on. A mechanism is preferably implemented here wherein persons from the group 1 can indicate their availability. The availability of each person is more preferably stored in a memory 3, and this availability of the persons from the group 1 can be modified by the persons from the group 1. A person wishing to take a break can thus indicate that he/she is not available. Depending on the type of event, the initial value relating to availability can indicate that the person is “available” or indicate that the person is “not available”. In the case the initial value is “not available”, each person must indicate at the beginning of the event that he/she is available before the person becomes part of the collection 6.

In step S4 one subgroup is selected from the persons in collection 6. The subgroup is preferably a pair here, i.e. subgroup 2 comprises two persons from collection 6. The skilled person will appreciate that the size of the subgroup can also differ from two, and can for instance also be three, four, five or six. The skilled person will then understand that the algorithm can be modified so that such subgroups are selectable from collection 6 by the algorithm. The subgroup is selected by performing the algorithm selected in step S3. Conditions concerning the forming of subgroups are specified in the algorithm. Each subgroup will thus combine persons only when the relation between persons is quantified above the predetermined threshold value. There is as a result a relatively strong chance of a positive outcome to a meeting between the persons in the subgroup. Further conditions can also form part of the algorithm, examples of which are given below.

After forming of a subgroup 1, an indication is given in step S5 for each person from the subgroup of step S4 that the person has been assigned to a subgroup. This indication can be implemented in different ways, for instance by changing the availability value from “available” to “not available”. A further value can alternatively be stored in memory 3 which indicates whether a person has been assigned to a subgroup. It will be apparent that this indication is used when step S4 is repeated in the method because the persons assigned to a subgroup no longer form part of collection 6.

After forming of a subgroup and indication of the persons assigned to the subgroup, a check is made in monitoring step C1 of whether almost all persons from collection 6 have been assigned. For this purpose a so-called remaining number can be set or predetermined as absolute value or as percentage of the number of persons in the group 1. In monitoring step C1 a check is then made of whether the number of persons in collection 6 is smaller than the remaining number. If the answer is yes, step S6 will be performed, being communication of the subgroups to the persons from the group 1. This is typically performed by a human-machine interface 5 such as a screen, beamer or an audio signal. Assignment can alternatively be communicated to smart phones or other personal electronic communication devices of the persons from group 1. This can be implemented for instance by sending a message such as an SMS or by sending another type of digital message, for instance via a custom-made software application. When the event is a very large event, i.e. with more than 80 participants, the algorithm can be provided so as to take into account the physical location of the persons on the premises where the event is taking place. For each subgroup a location on the premises where the event is taking place can further be indicated and communicated to the persons from the group 1.

When monitoring step C1 shows that almost all available persons from collection 6 have not yet been assigned to subgroups 7, the method continues with monitoring step C2. A check is made in monitoring step C2 of whether it is possible in the collection 6 of available persons to make a subgroup wherein the relation is quantified above the predetermined threshold value. If the answer is yes, the method is repeated from step S4. Steps S4, S5, C1 and C2 are in this way repeated until all persons from the collection have been assigned to subgroups.

When the second monitoring step C2 has as outcome that it is not possible to make a subgroup from the collection wherein the relation is quantified above the predetermined threshold value, the method is performed again from step S3. This means that the subgroups which have been formed by performing steps S4 and S5 are removed or cancelled, and that an algorithm which has not yet been applied is selected for the purpose of forming subgroups in step S4. Following selection of a new algorithm the steps S4, S5, C1 and C2 are again performed repetitively until either all persons from collection 6 have been assigned to subgroups, or monitoring step C2 once again shows that it is not possible to assign all persons to subgroups wherein the relation is quantified above a predetermined threshold value. The different algorithms are preferably stored in a memory 3, which algorithms are selected successively in step S3 each time monitoring step C2 shows that step S3 must be repeated. It will be apparent here that, each time monitoring step C2 shows that step S3 must be repeated, an algorithm is selected which has not been applied before. Steps S4 and S5 are performed again with this selected algorithm.

When monitoring step C2 shows that all available algorithms from the memory have been applied, and it has still been found impossible to assign the whole collection 6 to subgroups, the method is repeated from step S2. This means that the method is repeated with a lower predetermined threshold value. It will be apparent here that all algorithms of step S3 can be tried out again with the lower predetermined threshold value in order to assign the group to subgroups.

Preferably stored in step S6 in the case of each person assigned to subgroups 7 is which other person or persons are in the subgroup. This is preferably stored in a memory 3 connected to processor 4. This information is preferably used in the algorithm of step S4 at a later time in the event in order to prevent persons being assigned to the same subgroup.

When the persons have been assigned to subgroups 7, they can become acquainted with each other. When the persons of a subgroup 7 have in their own opinion become sufficiently acquainted with each other, these persons can decide to make themselves available for assignment to a new subgroup. This is illustrated with arrow 8 in FIG. 1.

The method of FIG. 2 is preferably performed repeatedly at intervals of N-minutes, for instance three minutes or five minutes. The collection of available persons 6 is hereby assigned to subgroups every N-minutes. The efficiency of the event can hereby be maximized for the participants.

Given below is a highly simplified example of the operation of the method of FIG. 2. The method begins with step S1, from which for instance the table below results.

| | Person 1 | Person 2 | Person 3 | Person 4 |
|---|---|---|---|---|
| Person 1 | | 20 | 60 | 53 |
| Person 2 | 20 | | 94 | 37 |
| Person 3 | 60 | 94 | | 10 |
| Person 4 | 53 | 37 | 10 | |

In step S2 a threshold value is predetermined, for instance at 50. This means that the subgroups must be formed with persons having a relation quantified higher than 50.

In step S3 a first algorithm is selected from the list with available algorithms. The first algorithm of the example is provided for the purpose of scanning the table from top to bottom and from left to right in order to thus make subgroups.

In step S4 a first subgroup is formed by performing the algorithm selected in step S3. The algorithm starts at the top, i.e. at person 1. The algorithm further operates from left to right, i.e. person 2 is considered first. However, because the relation between person 1 and person 2 is quantified at 20, i.e. well below the predetermined threshold value of 50, person 2 is not selected for person 1. Because the algorithm runs from left to right, the following person considered is person 3. Person 3 and person 1 have a relation quantified at 60, i.e. above the threshold value of 50. A subgroup of person 1 and person 3 is formed as a result.

Indicated for person 1 and person 3 in step S5 is that they have been assigned to a subgroup. Monitoring step C1 is then performed. In monitoring step C1 a check is made as to whether it is possible from the collection of available persons to make a subgroup wherein the relation is quantified above the threshold value. In the example, where person 1 and person 3 have already been assigned to a subgroup, person 2 and person 4 still remain. However, the relation between person 2 and person 4 is quantified at 37. This is below the predetermined threshold value. Step S4 is not therefore repeated (it is no longer possible to form a subgroup). The method continues with monitoring step C2. Determined in monitoring step C2 is that all algorithms have not yet been performed on the collection. The method is repeated for this purpose from step S3.

In step S3 an algorithm which has not yet been applied is selected which likewise runs from top to bottom and then from right to left. This algorithm is then applied in step S4, in which person 1 is once again selected because the algorithm runs from top to bottom. Person 4 is also considered because the algorithm runs from right to left. Person 4 and person 1 have a relation quantified at 53, i.e. above the threshold value. Person 1 and person 4 are therefore placed in a subgroup, after which step S5 is performed. Checked in monitoring step C1 is whether all persons have already been assigned, which is not the case since person 2 and person 3 have not yet been assigned to a subgroup.

The method therefore continues with monitoring step C2, which indicates that it is indeed still possible to form a new subgroup since person 2 and person 3 have a relation which is quantified at 94, i.e. above the threshold value. The method is therefore repeated from step S4. In step S4 person 2 and person 3 are assigned to a subgroup. In the following step S5 an indication is given for person 2 and person 3 that they have been assigned to a subgroup. Monitoring step C1 determines that all persons from collection 6 have been assigned to subgroups, after which step S6 is performed and the subgroups are communicated.

The simple example above shows how different algorithms can assign the same group in a different way, wherein a first algorithm may not be successful and a second algorithm may well be successful. On the basis hereof it will be apparent to the skilled person that the method can be optimized by applying a plurality of algorithms.

When collection 6 is odd and the subgroups are pairs, it is by definition impossible to assign all persons from the collection to a subgroup. In such a case an indication is preferably made for the remaining person in the collection who has not been assigned to a subgroup that this person has not been assigned during the forming of subgroups. This indication can be taken into account in the algorithm at a later stage during the event in order to ensure that only once during the event is each person from the group 1 not assigned to a subgroup Persons are alternatively added to the group 1 to enable forming of the subgroups. This is possible in a situation wherein an event comprises a plurality of groups, wherein persons from the one group can be transferred to the other group.

It will be apparent on the basis of the above description that it is possible to envisage different ways of embodying and optimizing the method according to the invention in practice. The invention is therefore not limited to the described examples, and will be defined solely in the claims.

1. A method for forming subgroups within a group, wherein the group comprises a predetermined number of persons and wherein a database is available which quantifies a relation between each possible pair of the group, wherein the method comprises of repetitively performing the steps, by means of a processor, of:
forming a subgroup from a collection of persons from the group not yet assigned to subgroups by selecting a set of persons from the group according to a predetermined algorithm in a manner such that the relation between persons in the set is quantified above a predetermined threshold value;
designating each person from the set of persons as persons assigned to subgroups;
wherein the repetitive performance stops in one of the following situations:
the collection of persons from the group not yet assigned to subgroups comprises fewer than a predetermined remaining number of persons, after which the method further comprises of communicating the subgroups via a user interface; and
in the collection of persons from the group not yet assigned to subgroups the relations are quantified below the predetermined threshold value, after which the method further comprises the following step of:
restarting the repetitive performing of the steps with a further predetermined algorithm differing from predetermined algorithms previously applied in the method.

2. The method as claimed in claim 1, wherein the subgroup is a pair.

3. The method as claimed in claim 1, wherein the method further comprises the following steps, when the step of restarting repetitive performing of the steps with a further predetermined algorithm differing from predetermined algorithms previously applied in the method has been exhausted, of:
repeating the whole method with a further predetermined threshold value lower than previously applied predetermined threshold values.

4. The method as claimed in claim 1, wherein a plurality of predetermined algorithms is stored in a memory, which memory is operatively connected to the processor.

5. The method as claimed in claim 1, wherein the database is stored in a memory, which memory is operatively connected to the processor.

6. A method for controlling meetings between persons during an event, wherein the method comprises:
setting a predetermined period of time per meeting,
performing the method as claimed in claim 1 for each period of time; and
communicating the end of the predetermined period of time for each period of time.

7. The method as claimed in claim 6, wherein the step of communicating the subgroups via a user interface further comprises of storing, for each person from the subgroup, the other persons from the subgroup as relations, and wherein the set of persons is selected such that the set of persons is formed by persons who are not relations.

8. The method as claimed in claim 6, wherein the availability of persons in the group is dynamic and wherein the collection of persons from the group not yet assigned to subgroups comprises only the persons available.

9. The method as claimed in claim 8, wherein the database further comprises for each person an availability value which comprises the availability of each person, which availability value can be modified via a user interface connected to the processor and the memory.

10. The method as claimed in claim 1, wherein the relation is quantified by calculating an indication of complementarity between the persons.
